(19) United States
(12) Patent Application Publication
(10) Pub. No.: US 2006/0092104 A1
(43) Pub. Date: May 4, 2006

(54) Brightness controlling device for flat panel display and method of controlling the same

(76) Inventor: Mun Seok Kang, Anyang (KR)

Correspondence Address: CHRISTIE, PARKER & HALE, LLP, PO BOX 7068, PASADENA, CA, 91109-7068, US

(21) Appl. No.: 11/238,628

(22) Filed: Sep. 28, 2005

(30) Foreign Application Priority Data
Oct. 29, 2004 (KR) 10-2004-0086961

(51) Int. Cl. G09G 3/28

(52) U.S. Cl. 345/63

(57) ABSTRACT

A brightness controlling device for a flat panel display and a method of controlling brightness. The brightness controlling device for a flat panel display includes an operator adapted to calculate a brightness level of a video signal per unit image of the video signal, a comparator adapted to compare the calculated brightness level with a reference brightness level to generate a comparison result, and a PWM clock generator to convert a frequency of a PWM clock corresponding to the video signal on the basis of the comparison result.

### CROSS-REFERENCE TO RELATED APPLICATION

This application claims priority to and the benefit of Korean Patent Application No. 10-2004-0086961, filed Oct. 29, 2004, in the Korean Intellectual Property Office, the entire content of which is incorporated herein by reference.

### BACKGROUND

1. Field of the Invention

The present invention relates to a brightness controlling device for a flat panel display and a method of controlling brightness, and more particularly, to a brightness controlling device for a flat panel display and a method of controlling brightness, in which brightness is controlled by converting (or adjusting) a brightness level of an input video signal.

2. Discussion of Related Art

In general, a flat panel display (FPD) includes a sealed container formed by interposing a sidewall between two substrates, and arranging suitable materials inside the sealed container so as to display an image. The FPDs recently have been gaining importance together with the development of multimedia. Accordingly, various FPDs such as a liquid crystal display (LCD), a plasma display panel (PDP), an electron emission display and the like have been developed and/or are in use.

In particular, an electron emission display employs an electron beam and a fluorescent body for emitting light like a cathode ray tube (CRT), so that the electron emission display has merits of the CRT and at the same time can be realized as an FPD that consumes low power while displaying an image without distorting the image. Further, the electron emission display has been gaining attention as a next generation display device because the electron emission display has advantages of a wide viewing angle, fast response, high brightness, a fine pitch, a thin shape, etc.

The electron emission display has a triode structure including a cathode electrode, an anode electrode and a gate electrode. For example, a cathode electrode is formed on a substrate and generally used as a scan electrode. On the cathode electrode, an insulating layer having a hole and a gate electrode generally used as a data electrode are formed in sequence. Further, an emitter used as an electron emission source is placed inside the hole of the insulating layer. The emitter is in contact with the cathode electrode electrically.

In the electron emission display with this configuration, when a high electric field is concentrated on the emitter, the emitter emits electrons due to the tunnel effect based on quantum mechanics. Then, the electrons emitted from the emitter are accelerated by a voltage applied between the cathode electrode and the anode electrode, and collide with red, green and blue (RGB) fluorescent layers, thereby emitting light to display an image.

The brightness of an image, which is displayed when the electrons collide with the fluorescent layer and light is emitted, varies corresponding to a value of an input digital video signal. For example, the digital video signal includes R data of 8 bits, G data of 8 bits, and B data of 8 bits. That is, the digital video signal has a value that ranges from 0(00000000₍₂₎) to 255(11111111₍₂₎). Thus, 256 gray levels can be represented by 256 digital values, thereby representing the brightness of color according to the digital values.

To control the brightness based on the digital values, a pulse width modulation (PWM) method or a pulse amplitude modulation (PAM) method is generally used.

In the case of the PWM method, the pulse width of a driving waveform applied to the data electrode is modulated according to the input digital video signal. When a digital video signal of 255 is inputted within a maximum allowable on-time, the pulse width has the maximum value, thereby representing the highest brightness. When a digital video signal of 127 is inputted, the pulse width has a half value, so that the brightness is lowered as compared with the highest brightness.

On the other hand, in the case of the PAM method, the pulse width is constant regardless of the input digital video signal, but a pulse voltage level, i.e., the amplitude of pulse of the driving waveform, varies according to the input digital video signal, thereby controlling the brightness.

However, in such a conventional electron emission display, when a digital video signal of 255 (R:11111111₍₂₎, G:11111111₍₂₎, B:11111111₍₂₎) is inputted to a data electrode driver, the brightness is determined by the PWM or PAM method on the basis of the value (255) of the digital video signal regardless of a full white mode or a white window mode (refer to FIG. 1), wherein the full white mode indicates that the whole image is white, but the white window mode indicates that only a portion of an image is white. In other words, when the data electrode driver receives a digital video signal of 255, the brightness is determined without considering the overall brightness levels of the digital video signals. As a result, there is no difference between brightness in the full white mode and brightness in the white window mode.

Thus, it is difficult to expect visual characteristics of white in a case of a moving picture. Also, in the case of the full white mode, the amount of current flowing in the emitter on the cathode electrode is increased, thereby generating an arc and thus decreasing the life span of the electron emission display.

### SUMMARY OF THE INVENTION

Accordingly, it is an aspect of the present invention to provide a brightness controlling device for a flat panel display and a method of controlling brightness, in which the brightness is controlled by changing a PWM clock according to brightness levels of an input digital video signal.

The forgoing and/or other aspects of the present invention are achieved by providing a brightness controlling device for a flat panel display, including: an operator adapted to calculate a brightness level of a video signal; a comparator adapted to compare the calculated brightness level with a reference brightness level to generate a comparison result; and a PWM clock generator adapted to convert a frequency of a PWM clock corresponding to the video signal on the basis of the comparison result.

According to an embodiment of the present invention, the operator may be adapted to calculate the brightness level per unit image of the video signal. The unit image may include a video signal corresponding to one or more horizontal lines. Alternatively, the unit image may include a video signal corresponding to one or more frames. Further, the brightness controlling device may include a storage adapted to store video data per unit image of the video signal. The PWM clock generator may be adapted to increase the frequency of the PWM clock in response to the comparison result when the video signal has a high brightness level. The operator may include an adder adapted to add video data per unit image of the video signal, and a divider adapted to calculate an average of a sum generated by the adder.

Another aspect of the present invention is achieved by providing a method of controlling brightness for a flat panel display, the method including: calculating a brightness level of a video signal; comparing the calculated brightness level with a reference brightness level to generate a comparison result; and controlling the brightness level by converting a frequency of a PWM clock corresponding to the video signal on the basis of the comparison result.

According to an embodiment of the present invention, clock cycles corresponding to the converted frequency of the PWM clock may be counted, and a gray level of the video signal may be represented corresponding to time taken to count the clock cycles. Alternatively, clock cycles corresponding to the converted frequency of the PWM clock may be counted, and a gray level of the video signal may be represented by increasing a voltage level in proportion to a counted number of the clock cycles. Calculating the brightness level of the video signal may include calculating the brightness level of the video signal per unit image of the video signal. The unit image may include a video signal corresponding to one or more horizontal lines. Alternatively, the unit image may include a video signal corresponding to one or more frames. Further, the method may further include storing video data per unit image of the video signal. Also, the method may further include increasing the frequency of the PWM clock in accordance with the comparison result when the video signal has a high brightness level.

Yet another aspect of the present invention is achieved by providing a flat panel display including: a panel for displaying an image corresponding to a video signal; a scan electrode driver for providing a scan signal to the panel; a data electrode driver for providing a driving waveform corresponding to the video signal to the panel; and a brightness controlling device. The brightness controlling device includes an operator adapted to calculate a brightness level of the video signal, a comparator adapted to compare the calculated brightness level with a reference brightness level to generate a comparison result, and a PWM clock generator adapted to convert a frequency of a PWM clock corresponding to the video signal on the basis of the comparison result. The PWM clock generator generates the PWM clock and an on-time signal, and provides the PWM clock and the on-time signal to the data electrode driver and the scan electrode driver, respectively.

### BRIEF DESCRIPTION OF THE DRAWINGS

These and/or other aspects and features of the invention will become apparent and more readily appreciated from the following description of exemplary embodiments, taken in conjunction with the accompanying drawings of which:

FIG. 1 illustrates a full white mode in which an image is entirely white, and a white window mode in which only a portion of an image is white;

FIG. 2 is a block diagram of a flat panel display including a brightness controlling device according to an embodiment of the present invention;

FIG. 3 shows a timing changes of a scan signal and a PWM clock on the basis of a brightness level of a unit video signal according to an embodiment of the present invention;

FIG. 4A is a graph showing a method for representing a gray level by counting the PWM clock according to an embodiment of the present invention;

FIG. 4B is a graph showing another method for representing gray level by counting the PWM clock according to another embodiment of the present invention; and

FIG. 5 is a sectional view of a panel structure of the flat panel display according to an embodiment of the present invention.

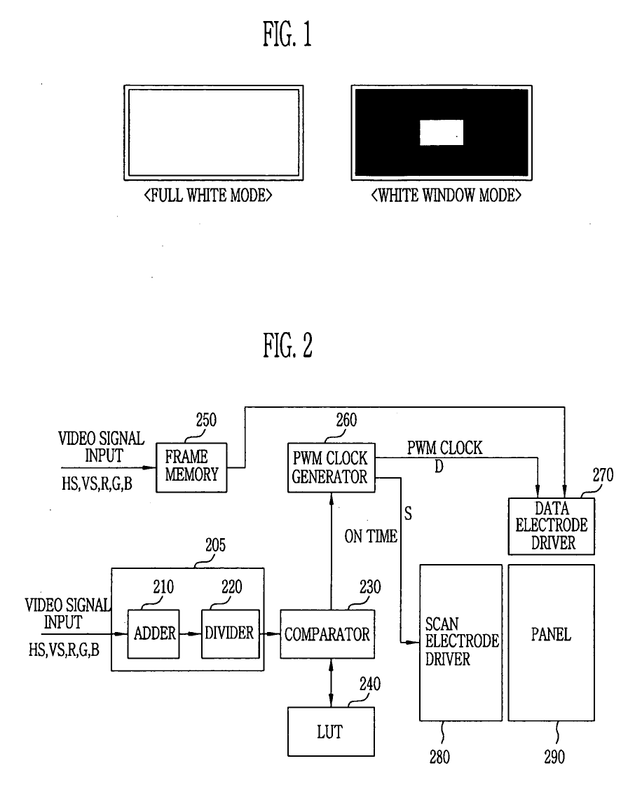

### DETAILED DESCRIPTION

Hereinafter, certain exemplary embodiments according to the present invention will be described in detail with reference to the accompanying drawings, wherein the exemplary embodiments of the present invention are provided to be readily understood by those skilled in the art. The present invention is not limited to the following embodiments disclosed herein.

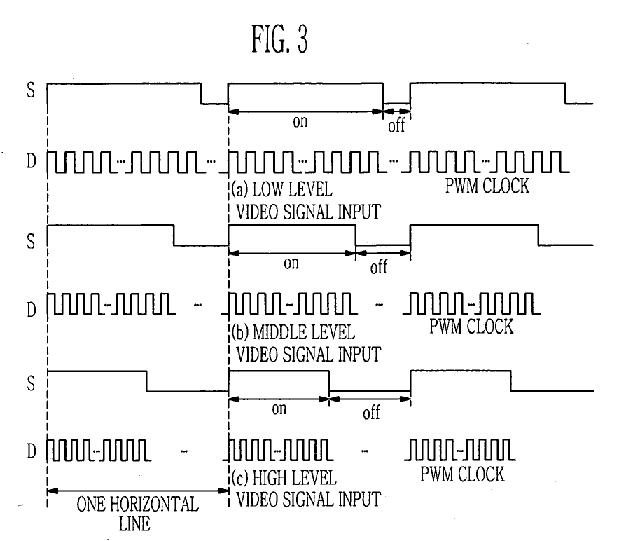

FIG. 2 is a schematic block diagram of a flat panel display including a brightness controlling device according to an embodiment of the present invention.

Referring to FIG. 2, the brightness controlling device for the flat panel display according to an embodiment of the present invention includes an operator 205 for calculating a brightness level of a video signal (e.g., per unit image of the video signal), a comparator 230 for comparing the calculated brightness level with a reference brightness level (which may be preset), and a PWM clock generator 260 for converting (or adjusting) a PWM clock frequency (i.e., frequency of the PWM clock) corresponding to the video signal on the basis of the comparison result.

In more detail, the flat panel display with a driver for displaying an image based on an input video signal, includes the operator 205 for calculating the brightness level indicating the whole image per unit image of the video signal, a frame memory (or storage) 250 for storing video data per unit image of the video signal, the PWM clock generator 260 for generating a PWM clock and an on-time signal of the video signal on the basis of the brightness level calculated by the operator 205, a data electrode driver 270 for supplying the video data stored in the frame memory 250 and the PWM clock generated by the PWM clock generator 260 to a panel 290, and a scan electrode driver 280 for supplying the on-time signal generated by the PWM clock generator 260 to the panel 290. In other embodiments, any other suitable memory or storage medium may be used as the storage instead of the frame memory 250.

The operator 205 includes an adder 210 for adding the video data per unit image, and a divider 220 for calculating an average of the sum generated by the adder 210. Here, the unit image may include a video signal corresponding to one or more horizontal lines, a video signal corresponding to one or more frames, and so on. To reduce or minimize a distortion of the video signal while the video signal is processed, the unit image may include a video signal corresponding to one frame. According to an embodiment of the present invention, one frame is used as the unit image for determining the brightness level, which will be described hereinbelow.

The adder 210 receives a horizontal synchronous signal HS, a vertical synchronous signal VS, and the video signal including RGB data. To calculate the brightness level of the video signal per frame, the adder 210 respectively adds an R data of 8 bits, a G data of 8 bits, and a B data of 8 bits corresponding to one frame, i.e., an active section of one vertical synchronous signal VS. Then, the added results are outputted to the divider 220 to calculate the average of one unit frame.

The divider 220 calculates each average of the R data of 8 bits, the G data of 8 bits, and the B data of 8 bits. Thus, the brightness of the video signal is determined on the basis of the averages, respectively, of the R data, G data and B data. In the case where an average brightness level calculated by the divider 220 is high, the whole image is bright. On the other hand, in the case where an average brightness level calculated by the divider 220 is low, the image is relatively dark.

According to an embodiment of the present invention, there is provided a look-up table (LUT) 240 that stores reference brightness levels and/or averages thereof for the video data, and data converting indexes corresponding to levels of brightness (or darkness) of the image that are divided on the basis of the reference brightness levels and/or the averages thereof. In other embodiments, the data conversion may be achieved using logic in the comparator 230 without the LUT 240.

The comparator 230 compares the average of a predetermined frame calculated by the divider 220 with the average of the reference brightness level stored in the LUT 240. The comparator 230 determines a PWM clock converting index and an on-time converting index for the video signal according to the brightness levels of a predetermined frame, and outputs them to the PWM clock generator 260.

As the storage, the frame memory 250 stores the video data corresponding to one frame while the video signals of the corresponding frame are averaged and compared with the reference brightness level of the LUT 240, and outputs the stored video data when the PWM clock signal is transmitted to the data electrode driver 270.

The PWM clock generator 260 outputs the PWM clock and the on-time signal, which are converted on the basis of the PWM clock converting index and the on-time converting index determined by the comparator 230, to the data electrode driver 270 and the scan electrode driver 280, respectively. Here, the PWM clock generator 260 selects an optimum (or suitable) clock frequency among a plurality of preset clock frequencies for the brightness level on the basis of the comparison results, and outputs the optimum (or suitable) clock frequency to the data electrode driver 270.

For example, when the input video signal has a high brightness level in a case such as that of the full white mode, the on-time signal outputted to the scan electrode driver 280 has a low value, but the PWM clock frequency has a relatively high value to represent its gray level. On the other hand, when the input video signal has a low brightness level in a case such as that of the white window mode, the on-time signal outputted to the scan electrode driver 280 has a high value, but the PWM clock frequency has a relatively low value to represent its gray level.

The data electrode driver 270 transmits a data signal to a data line (not shown), and the data signal represents the gray level according to a counted number of PWM clock cycles.

The scan electrode driver 280 transmits a low or high signal to a scan line (not shown) for a predetermined period according to a predetermined horizontal line of the panel 290 so as to select the predetermined horizontal line for the predetermined period, and generates an on-time determination signal such as a blanking signal in correspondence to the on-time.

The panel 290 includes a plurality of data lines (gate electrode or cathode electrode) and a plurality of scan lines (cathode electrode or gate electrode), which cross or intersect with each other, wherein a pixel (not shown) is formed at the intersection region. The pixel includes a gate electrode and a cathode electrode, and receives the data signal and the scan signal through the data line and the scan line, respectively. Here, the scan signal inputted through the scan line selects the plurality of pixel horizontal lines in sequence, and the data signal is transmitted through the data line to the pixel horizontal lines selected by the scan signal, so that the pixel emits the light and forms an image.

Hereinbelow, a method of controlling the brightness in the brightness controlling device for the flat panel display illustrated in FIG. 2 will be described. The method of controlling the brightness includes calculating a brightness level per unit image of the video signal, comparing the calculated brightness level with the reference brightness level (which may be preset), and controlling the brightness level per unit image by converting the PWM clock frequency corresponding to the video signal on the basis of the comparison result.

The storage (i.e., frame memory 250) stores the video data corresponding to the unit image. The frame memory may store the video data corresponding to the unit frame.

Then, the adder receives the video signal together with the horizontal synchronous signal and the vertical synchronous signal. For example, to calculate the brightness level of the video signal per frame, the adder respectively adds the R data of 8 bits, the G data of 8 bits, and the B data of 8 bits corresponding to one frame, i.e., the active section of one vertical synchronous signal VS. Then, the added results are outputted to the divider to calculate the average of one unit frame.

Then, the divider calculates each average of the R data of 8 bits, the G data of 8 bits, and the B data of 8 bits. Thus, the brightness of the video signal is determined on the basis of the averages. In the case where an average brightness level calculated by the divider is high, the whole image is bright. On the other hand, in the case where an average brightness level calculated by the divider is low, the image is relatively dark.

Further, the LUT 240 stores reference brightness levels and/or averages thereof for the video data, and data converting indexes corresponding to levels of brightness (or darkness) of the image that are divided on the basis of the reference brightness levels and/or the averages thereof.

Then, the comparator compares the average of a predetermined frame calculated by the divider with the average of the reference brightness level stored in the LUT. The comparator 230 determines a PWM clock converting index and an on-time converting index for the video signal according to the brightness levels of a predetermined frame, and outputs them to the PWM clock generator.

Then, the frame memory 250 stores the video data corresponding to one frame while the video signals of the corresponding frame are averaged and compared with the reference brightness level of the LUT, and outputs the stored video data when the PWM clock signal is transmitted to the data electrode driver 270.

The PWM clock generator outputs the PWM clock and the on-time signal, which are respectively converted on the basis of the PWM clock converting index and the on-time converting index determined by the comparator, to the data electrode driver and the scan electrode driver, respectively.

FIG. 3 shows timing changes of a scan signal and a PWM clock on the basis of a brightness level of a unit video signal according to an embodiment of the present invention. Referring to FIG. 3, while the PWM clock and the on-time signal generated by the PWM clock generator are applied to the data electrode driver and the scan electrode driver, respectively, a process of controlling the brightness level of a unit image, i.e., the brightness level of the video signal corresponding to the unit frame, will be described.

As shown in FIG. 3, when a video signal has a relatively high brightness level in a case such as that of the full white mode (refer to (c) of FIG. 3), the on-time signal outputted to the scan electrode driver should have a relatively low value, but the PWM clock frequency should have a relatively high value to represent its gray level. In this case, even though the high brightness level video signals are the data signal having the same gray level, when the PWM clock frequency is high, the on-time of driving an electron emission device (not shown) is decreased but the off-time thereof is increased. Thus, the electron emission device is prevented from being easily deteriorated due to the high brightness level, and is protected from arcing due to the high brightness level.

When a video signal has a relatively low brightness level in a case such as that of the white window mode (refer to (a) of FIG. 3), the on-time signal outputted to the scan electrode driver should have a relatively high value, but the PWM clock frequency should have a relatively low value to represent its gray level. In this case, even though the low brightness level video signals are the data signals having the same gray level, when the PWM clock frequency is low, the on-time of driving the electron emission device is decreased but the off-time thereof is increased.

As compared with the conventional PWM method that counts the number of PWM clock cycles and represents the gray level corresponding to the number of PWM clock cycles, an embodiment of the present invention represents the gray level by converting the PWM clock frequency per unit video signal on the basis of the brightness level determined per unit video signal, so that the amount of electron emission is relatively decreased with regard to the video signal having the relatively high brightness level, but the amount of electron emission is relatively increased with regard to the video signal having the relatively low brightness level.

As described above, the present invention includes configuration to convert the PWM clock frequency, and thus creates two or more PWM clock frequencies, thereby outputting the PWM clock having different frequencies according to the brightness levels of the video signal. Thus, white is actively represented while an image such as a moving picture is displayed, without distorting the input video signal.

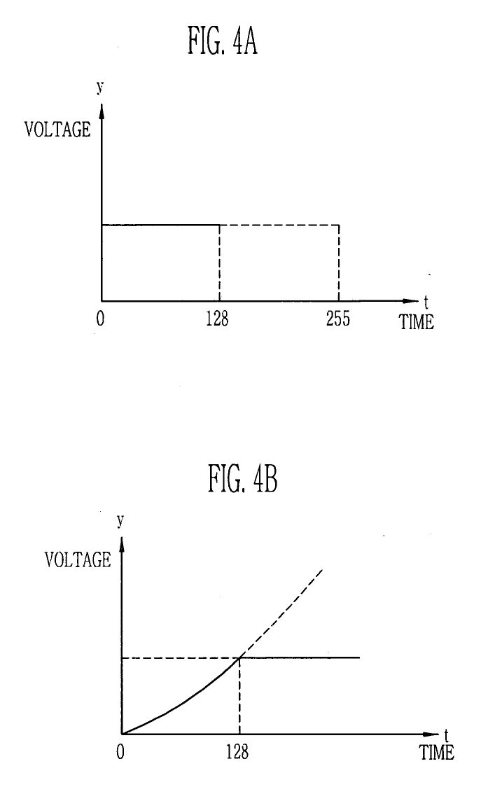

FIG. 4A is a graph showing a method for representing gray level by counting the PWM clock cycles according to an embodiment of the present invention, and FIG. 4B is a graph showing another method for representing gray level by counting the PWM clock cycles according to an embodiment of the present invention.

Referring to FIG. 4A, the input video signal has a gray level of 128 by way of example, and thus 128 PWM clock cycles are counted. Here, a constant level voltage is applied to the panel for a time of counting the PWM clock cycles, thereby representing the brightness of the video signal.

Referring to FIG. 4B, the input video signal has a gray level of 128 by way of example, and thus 128 PWM clock cycles are counted. Here, a voltage is increased for a time of counting the PWM clock cycles and then applied to the panel, thereby representing the brightness of the video signal.

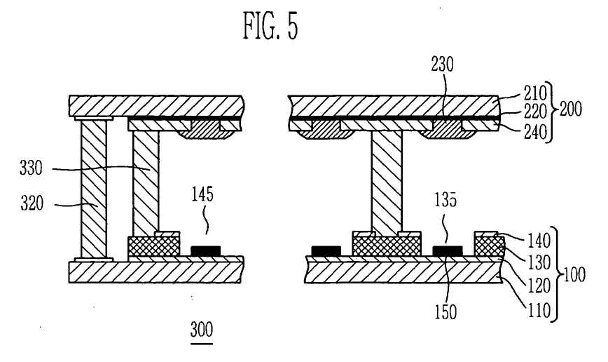

FIG. 5 is a sectional view of a panel structure of the flat panel display according to an embodiment of the present invention, wherein the panel is driven by a matrix type and displays an image according to the brightness level per unit image. However, the panel according to an embodiment of the present invention is not limited thereto. Alternatively, the panel may have various structure as long as it can represent the gray level of the video signal corresponding the brightness level.

Referring to FIG. 5, an electron emission substrate 100 includes at least one electron emission device disposed thereon, wherein the electron emission device includes an emitter 150 electrically connected to a cathode electrode 120 and emitting electrons when electric field is applied between the cathode electrode 120 and a gate electrode 140. Here, the electron emission device has a top gate structure, but is not limited thereto. Alternatively, the electron emission device may have various structures such as a bottom gate structure, a double gate structure, or the like as long as it can emit electrons.

At least one cathode electrode 120 is arranged as a predetermined shape, e.g., a stripe shape, on a rear substrate 110. The rear substrate 110 includes a general glass or silicon substrate. In the case where the emitter 150 is formed by applying rear-exposure to a carbon nano tube (CNT) paste, the rear substrate 110 may include a transparent substrate such as the glass substrate.

The cathode electrode 120 supplies the data signal and the scan signal from a data electrode driver (e.g., the data electrode driver 270 of FIG. 2) and a scan electrode driver (e.g., the scan electrode driver 280 of FIG. 2) to the electron emission device, respectively. Here, the electron emission device includes the emitter 150 that is formed in a region defined by intersection of the cathode electrode 120 and the gate electrode 140. The cathode electrode 120 may be made of indium tin oxide (ITO) like the substrate 110.

An insulating layer 130 is formed on the rear substrate 110 and the cathode electrode 120, and electrically insulates the cathode electrode 120 from the gate electrode 140. Here, the insulating layer 130 has at least one first hole 135 formed at the intersection regions of the cathode electrodes 120 and the gate electrodes 140 so as to expose the cathode electrode 120 therethrough.

The gate electrode 140 is formed on the insulating layer 130 as a predetermined shape such as a stripe shape, and arranged to cross or intersect the cathode electrode 120. Here, the gate electrode 120 supplies the data signal and the scan signal from the data electrode driver and the scan electrode driver to the electron emission devices, respectively. Further, the gate electrode 140 has at least one second hole 145 corresponding to the first hole 135 so as to expose the emitter 150 therethrough.

The emitter 150 is placed on the cathode electrode 120 exposed through the first hole 135 of the insulating layer 130, and is electrically connected to the cathode electrode 120. Here, the emitter 150 may be made of nano tube such as carbon nano tube (CNT), graphite, graphite nano fiber, diamond-like-carbon, fullerene (C₆₀), silicon nano wire, or any suitable combination thereof.

An image forming substrate 200 includes a front substrate 210, an anode electrode 220 formed on the front substrate 210, fluorescent materials 230 formed on the anode electrode 220 and emitting light corresponding to the electrons emitted from the emitter 150, and an optical shielding layer 240 formed between the fluorescent materials 230.

On the front substrate 210, the fluorescent materials 230 are arranged at predetermined intervals. The electrons emitted from the emitter 150 collide on the fluorescent materials 230, thereby emitting light. Here, each of the fluorescent materials 230 indicates a monochromic fluorescent material. According to an embodiment of the present invention, the fluorescent materials correspond to R, G and B colors, respectively, but are not limited thereto. The front substrate 210 may be made of a transparent material to transmit the light from the fluorescent materials 230 to the outside.

The anode electrode 220 is formed on the front substrate 210, and used for focusing the electrons emitted from the emitter 150. Here, the anode electrode 220 is made of a transparent material. By way of example, the anode electrode 220 may be made of ITO.

The optical shielding layer 240 absorbs and blocks external light so as to prevent optical cross-talk, thereby enhancing contrast. Here, the optical shielding layer 240 is formed between the fluorescent materials 230 at a predetermined distance from each other.

Further, at least one spacer 330 is provided to support the electron emission substrate 100 and the image forming substrate 200 and maintain a vacuum space between the electron emission substrate 100 and the image forming substrate 200 against an atmospheric pressure applied to a panel 300. The spacer 330 has a first end contacting the optical shielding layer 240, and a second end contacting the insulating layer 130.

The panel 300 described above is maintained in a vacuum state by sealing up the electron emission substrate 100 and the image forming substrate 200, and further includes a supporting frame 320 to support the electron emission substrate 100 and the image forming substrate 200. An external power source applies a positive voltage to the cathode electrode 120, a negative voltage to the gate electrode 140, and a positive voltage to the optical shielding layer 240. Therefore, an electric field is formed around the emitter 150 by a voltage difference between the cathode electrode 120 and the gate electrode 140, so that the emitter 150 emits the electrons. The emitted electrons are induced by a high voltage applied to the anode electrode 220, and collide with the fluorescent materials 230, thereby emitting light and representing the gray level of an image.

As described above, the present invention provides a brightness controlling device for a flat panel display and a method of controlling brightness, in which a PWM clock frequency is converted corresponding to a brightness level of an input video signal, and thus an optimum or suitable gray level is represented, thereby preventing an emission region from arcing and protecting a panel.

Further, white is actively represented even though the input video signal has a low level, thereby enhancing the representation of the gray level.

Although certain exemplary embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brightness controlling device for a flat panel display, comprising:
an operator adapted to calculate a brightness level of a video signal;
a comparator adapted to compare the calculated brightness level with a reference brightness level to generate a comparison result; and
a PWM clock generator adapted to convert a frequency of a PWM clock corresponding to the video signal on the basis of the comparison result.

2. The brightness controlling device according to claim 1, wherein the operator is adapted to calculate the brightness level per unit image of the video signal, the unit image corresponding to one or more horizontal lines.

3. The brightness controlling device according to claim 1, wherein the operator is adapted to calculate the brightness level per unit image of the video signal, the unit image corresponding to one or more frames.

4. The brightness controlling device according to claim 1, further comprising a storage adapted to store video data per unit image of the video signal.

5. The brightness controlling device according to claim 1, wherein the PWM clock generator is adapted to increase the frequency of the PWM clock in response to the comparison result when the video signal has a high brightness level.

6. The brightness controlling device according to claim 1, wherein the operator comprises:
an adder adapted to add video data per unit image of the video signal; and
a divider adapted to calculate an average of a sum generated by the adder.

7. The brightness controlling device of claim 1, wherein the PWM clock generator is adapted to generate an on-time signal representing a maximum allowable on-time for an image, and to decrease the maximum allowable on-time in response to the comparison result when the video signal has a high brightness level.

8. A method of controlling brightness for a flat panel display, the method comprising:
calculating a brightness level of a video signal;
comparing the calculated brightness level with a reference brightness level to generate a comparison result; and
controlling the brightness level by converting a frequency of a PWM clock corresponding to the video signal on the basis of the comparison result.

9. The method according to claim 8, wherein clock cycles corresponding to the converted frequency of the PWM clock are counted, and a gray level of the video signal is represented corresponding to time taken to count the clock cycles.

10. The method according to claim 8, wherein clock cycles corresponding to the converted frequency of the PWM clock are counted, and a gray level of the video signal is represented by increasing a voltage level in proportion to a counted number of the clock cycles.

11. The method according to claim 8, wherein calculating the brightness level of the video signal comprises calculating the brightness level of the video signal per unit image of the video signal, the unit image comprising a video signal corresponding to one or more horizontal lines.

12. The method according to claim 8, wherein calculating the brightness level of the video signal comprises calculating the brightness level of the video signal per unit image of the video signal, the unit image comprising a video signal corresponding to one or more frames.

13. The method according to claim 8, further comprising storing video data per unit image of the video signal.

14. The method according to claim 8, further comprising increasing the frequency of the PWM clock in accordance with the comparison result when the video signal has a high brightness level.

15. A flat panel display comprising:
a panel for displaying an image corresponding to a video signal;
a scan electrode driver for providing a scan signal to the panel;
a data electrode driver for providing a driving waveform corresponding to the video signal to the panel; and
a brightness controlling device comprising:
an operator adapted to calculate a brightness level of the video signal;
a comparator adapted to compare the calculated brightness level with a reference brightness level to generate a comparison result; and
a PWM clock generator adapted to convert a frequency of a PWM clock corresponding to the video signal on the basis of the comparison result,
wherein the PWM clock generator generates the PWM clock and an on-time signal, and provides the PWM clock and the on-time signal to the data electrode driver and the scan electrode driver, respectively.

16. The flat panel display according to claim 15, wherein the operator is adapted to calculate the brightness level per unit image of the video signal, the unit image corresponding to one or more horizontal lines.

17. The flat panel display according to claim 15, wherein the operator is adapted to calculate the brightness level per unit image of the video signal, the unit image corresponding to one or more frames.

18. The flat panel display according to claim 15, wherein the brightness controlling device further comprises a storage adapted to store video data per unit image of the video signal.

19. The flat panel display according to claim 15, wherein the PWM clock generator is adapted to increase the frequency of the PWM clock in response to the comparison result when the video signal has a high brightness level.

20. The flat panel display according to claim 15, wherein the operator comprises:
an adder adapted to add video data per unit image of the video signal; and
a divider adapted to calculate an average of a sum generated by the adder.

21. The flat panel display according to claim 15, wherein the brightness controlling device further comprises a look-up table (LUT) adapted to store the reference brightness level and data converting indexes corresponding to levels of brightness or darkness of the video signal that are divided on a basis of the reference brightness level.
